(19) United States
(12) Patent Application Publication
(10) Pub. No.: US 2003/0048795 A1
(43) Pub. Date: Mar. 13, 2003

(54) Gateway between digital signal transmission networks

(75) Inventor: Francis Pinault, Bois-Colombes (FR)

Correspondence Address: SUGHRUE MION, PLLC, 2100 Pennsylvania Avenue, NW, Washington, DC, 20037-3213, US

(73) Assignee: ALCATEL

(21) Appl. No.: 10/237,896

(22) Filed: Sep. 10, 2002

(30) Foreign Application Priority Data
Sep. 13, 2001 (FR) 01 11 852

(51) Int. Cl. H04L 12/28

(52) U.S. Cl. 370/401

(57) ABSTRACT

A gateway can be provided between digital signal transmission networks where one of the networks is a private telecommunication network offering a GSM mobile telephone service using a GSM digital transmission protocol and the other network is the Internet. An internetwork gateway for setting up a call between a GSM, UMTS, PCS or Bluetooth first mobile telephone terminal connected to the private telecommunication network and another terminal which belongs to another network, can be addressed by means of an Internet address and is adapted to send and receive RTP/IP voice and/or UDP/IP or TCP/IP data, includes transcoders for transcoding information from the digital transmission protocol used in the first terminal to the protocol used in the second terminal and vice versa.

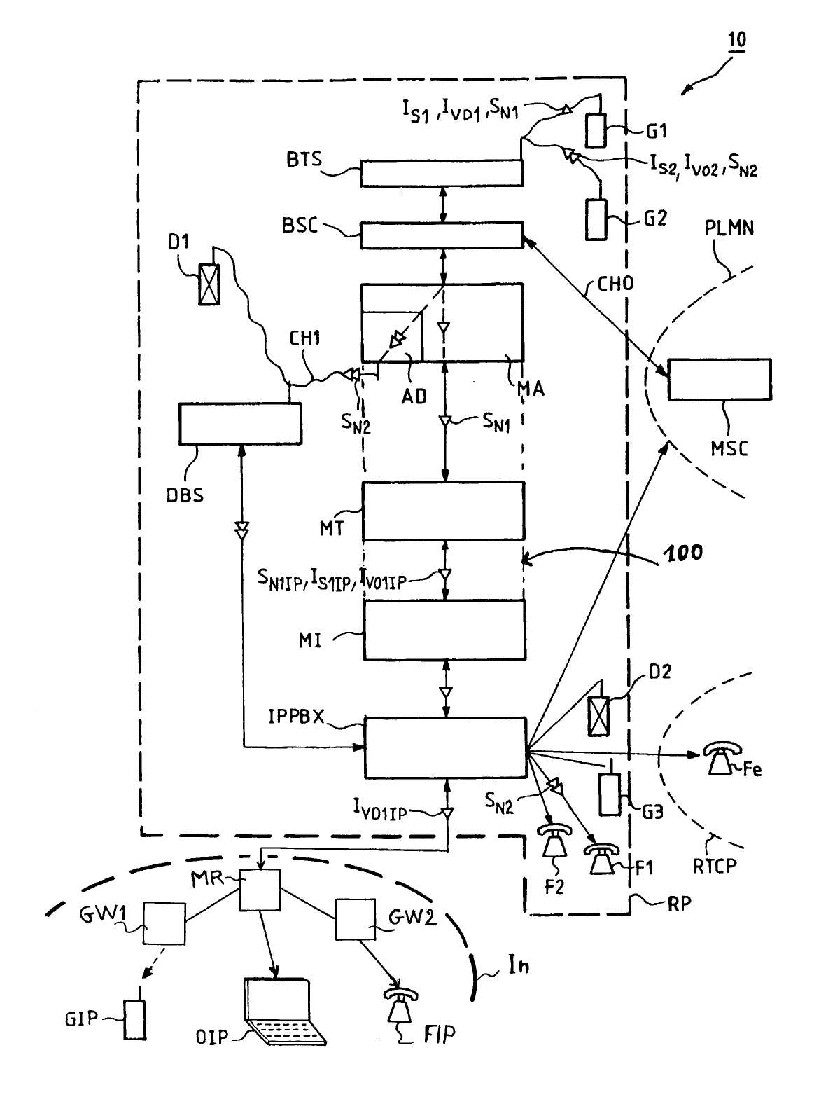

### CROSS-REFERENCE TO RELATED APPLICATIONS

This application is based on French Patent Application No. 01 11 852 filed Sep. 13, 2001, the disclosure of which is hereby incorporated by reference thereto in its entirety, and the priority of which is hereby claimed under 35 U.S.C. §119.

### BACKGROUND OF THE INVENTION

1. Field of the Invention

The present invention relates to the telecommunications art. It relates to a gateway for reducing the cost of using mobile telephones, especially the cost of using GSM (Global System for Mobile communications) mobile telephones connected to a private network to communicate with terminals outside the private network. To be more precise, it applies to the situation in which another terminal can be addressed by means of an Internet address and is adapted to send and receive RTP/IP voice and/or UDP/IP or TCP/IP data. The other terminal can be a landline telephone or a standard GSM telephone if adaptation is provided by an Internet gateway of a type known in the art which addresses the terminal by means of an Internet address and is able to change the format of voice signals.

2. Description of the Prior Art

Private telecommunication networks intended for a business or a group of businesses exist already. Their services are intended for employees and appropriately declared visitors or are rented to users and are circumscribed to an area. The document EP 1 073 294 describes a private network providing a GSM mobile telephone service. It comprises GSM base transceiver stations, a device equivalent to a GSM base station controller, and an access control device. The private network further includes an Internet Protocol computer local area network. A gateway using the Internet Protocol as its transport protocol provides the interface between the Internet Protocol computer local area network and a public GSM mobile telephone network. Voice/data signals sent or received by the GSM terminals of the private network are transported by the local area network and by the gateway, retaining their original format, which is defined by the interface designated the A interface in the GSM standard. The voice coders specified in the GSM protocol are the Enhanced Full Rate (EFR) coder or the Adaptive Multi Rate (AMR) coder defined by the International Telecommunication Union (ITU). The characteristics of calls supported by the mobile telephone network are preserved. The information elements transported are not transcoded, since the corresponding mobile telephone terminals in the public network are GSM terminals, just like the mobile telephone terminals of the private network.

The characteristics of the information elements described in the standards defining the Internet Protocol (IP) are conceived primarily for setting up calls between two points of the network in connected mode, unconnected mode, or a mode that guarantees a routing time and uses Real Time Protocol (RTP) packets. RTP packets are used to route GSM voice/data signals because of voice transmission delay constraints.

Thanks to the gateway, GSM terminal users of the private network can call terminals of the public GSM mobile telephone network, but the cost of a call to the public network is much higher than the cost of a call to a terminal that is also on the private network.

Some integrated services private networks offer a Digital European Cordless Telecommunications (DECT) cordless telephone service for local calls and a GSM or Personal Communications System (PCS) or Universal Mobile Telecommunications System (UMTS) mobile telephone service for national and international calls. A portion of a GSM communication network can be connected to an integrated services private network to offer the facility for routing some calls inside the integrated services private network. This is known in the art. For example, the patent application FR-27901 75 describes a server enabling GSM mobile telephone terminals to be used in a DECT private telecommunication network. These mobile telephone services convey digital signals and each of them uses a specific digital transmission protocol. The voice/data signals sent or received by the GSM terminals of the private network are transcoded by a server to enable the GSM terminals to benefit from the services of an exchange adapted to communicate only with DECT base stations or landline telephones.

In the case of a national or international call between a GSM terminal of the private network and a terminal that is not on the private network, the prior art systems automatically switch the call to the public mobile network if the called terminal is a mobile terminal or to the public fixed network if the called terminal is a fixed terminal. Thus the prior art systems are not able to send or receive national or international calls to or from mobile terminals connected to a private network, independently of a public telephone network. The rental charges for public networks paid by the private network operators are high, in particular for renting networks abroad.

The present invention proposes a device providing national or international calls between a mobile telephone terminal connected to a private network and a terminal which is not part of the private network, independently of a public telephone network.

### SUMMARY OF THE INVENTION

The invention provides an internetwork gateway for setting up a call between a GSM, UMTS, PCS or Bluetooth first mobile telephone terminal connected to a private telecommunication network and another terminal belonging to another network, addressable by means of an Internet address and adapted to send and receive RTP/IP voice and/or UDP/IP or TCP/IP data, which gateway includes transcoding means for transcoding information from the digital transmission protocol used in said first terminal to the protocol used in said second terminal and vice versa.

The Internet rental charge is up to ten times less than the charge paid to the private network operator for access to mobile telephone networks abroad. The gateway according to the invention therefore reduces the cost of national and international calls.

For example, a fixed private network such as that of a hotel or an onboard private network such as that on a ship, an oil rig or an aircraft, can offer customers or residents an advantageous international mobile telephone service thanks to the gateway according to the invention. Similarly, a business private network can use a gateway according to the invention to reduce the cost generated by national and international calls made by its employees and/or properly registered visitors using GSM or UMTS mobile terminals connected to the private network.

A digital signal on the private or Internet Protocol network comprises voice and/or data and signaling for call set-up and management. In one preferred embodiment, in relation to voice, the gateway according to the invention includes means for transcoding signaling from the digital transmission protocol used in the first terminal to a Real-time Transport Protocol (RTP) digital transmission protocol used for voice in the second terminal.

In a preferred embodiment, in relation to voice, the gateway according to the invention comprises interconnection means compatible with the Real-time Transport Protocol (RTP) digital transmission protocol used for voice in the second terminal.

One particular embodiment of the gateway according to the invention further includes an IP compatible private telephone switch for managing the transmission of digital signals between the networks.

Another particular embodiment of the gateway according to the invention further includes an Internet Protocol network router and a call server processing Internet Protocol call management protocols to manage the transmission of digital signals in accordance with the Internet Protocol between the networks.

The private network is a computer local area network or an integrated services private network.

The features and objects of the present invention will emerge from the following detailed description, which is given by way of illustrative and nonlimiting example and with reference to the accompanying drawing.

### BRIEF DESCRIPTION OF THE DRAWING

The single FIGURE of the accompanying drawing is a block diagram of one embodiment of a transmission system including an internetwork gateway according to the invention.

### DETAILED DESCRIPTION OF THE PREFERRED EMBODIMENT

The single FIGURE of the accompanying drawing shows a transmission system 10 including an internetwork gateway 100 according to the invention. The gateway 100 connects a private network RP to the Internet (In).

The private telecommunication network RP is a computer local area network offering a first mobile telephone service conforming to the GSM digital transmission protocol. The network RP sets up links with a plurality of GSM mobile stations such as terminals G1, G2 and G3. The private network RP also offers a second mobile telephone service, conforming to the DECT digital transmission protocol, and comprises a plurality of DECT terminals D1, D2. The network RP further comprises landline telephones F1, F2.

The Internet In uses the Internet Protocol and comprises routing means such as a router MR and various terminals:

terminals such as a computer OIP (or an IP dedicated telephone, not shown), which are each directly addressable by means of an Internet address and are capable of directly sending and receiving RTP/IP voice and/or UDP/IP or TCP/IP data, and

terminals such as a standard telephone terminal FIP and a GSM mobile telephone terminal GIP, which are each adapted by means of standard gateways (GW1 and GW2, respectively) to be addressed by an Internet address, and to be capable of sending and receiving RTP/IP voice and/or UDP/IP or TCP/IP data.

In order to be able to send and receive voice signals in real time that remain compatible with the Internet Protocol, the terminal OIP and the gateways GW1, GW2 all use a standard Real-time Transport Protocol (RTP).

To be more precise, voice signals are compressed and coded according to the ITU G.711, G.723 or G.729a standard.

The system 10 further includes a set of means used successively to transmit digital signals carrying telephone calls and/or data from a GSM terminal to a terminal connected to the Internet. The aforementioned means are primarily the internetwork gateway 100, which comprises:

switching means MA for switching digital signals and connected to an adapter AD,

transcoding means MT for transcoding digital signals and connected to the means MA, and

interconnection means MI compatible with the Internet Protocol and connected to the transcoding means MT and to a private branch exchange IPPBX supporting the Internet Protocol.

Consider, by way of a starting point for describing the path taken, the GSM terminals G1 and G2 and the evolution of respective digital signals S_{N1}, S_{N2} sent by the terminals G1, G2. The signals S_{N1}, S_{N2} contain signaling I_{S1}, I_{S2} and voice and/or data I_{VD1}, I_{VD2}.

As in the prior art, each terminal G1, G2 is linked by radio to a GSM base transceiver station BTS by radio links conforming to the GSM transmission protocol. It thus communicates with a base station controller BSC. Each signal S_{N1}, S_{N2} can be directed by the controller BSC, in a first configuration, to a path CH0 leading to the public land mobile network PLMN, thereby preserving the services provided under the GSM standard. In a second configuration, each signal S_{N1}, S_{N2} is sent by the controller BSC to the switching means MA. These switch each of the signals S_{N1}, S_{N2} as a function of the associated signaling.

In this example, the signaling I_{S2} for the signal S_{N2} read by the switching means MA indicates that the call is a local call. In a similar manner to the prior art system previously described, the switching means MA according to the invention then switch the signal S_{N2} to an adapter AD to render the GSM signaling protocol compatible with the signaling protocol specific to the private branch exchange IPPBX. The signal S_{N2} is then sent via the path CHI to a DECT base station DBS, and then to the IP-compatible private branch exchange IPPBX. The signal S_{N2} is then directed by the exchange IPPBX to one of the terminals D2, G3, F1, F2 of the private network connected to the exchange or to a fixed terminal Fe external to the private network, the private branch exchange IPPBX being connected to a fixed public network RTCP.

In this example, the signaling I_{S1} for the signal S_{N1} read by the switching means MA indicates that the call is a national or international call. The switching means MA then direct the signal S_{N1} to the transcoding means MT. The latter transcode voice and/or data I_{VD1} and signaling I_{S1} conforming to the GSM digital protocol into voice and/or data I_{VD1IP} and signaling I_{S1IP} conforming to the Internet Protocol, and vice versa, to enable dialog between the private network RP and the Internet In. The private network IPPBX is an IP-compatible private branch exchange, i.e. it satisfies Internet compatibility standards. It is coupled to the Internet router MR.

Examples of voice coders used in a GSM network are the Enhanced Full Rate (EFR) coder and the Adaptive Multi Rate (AMR) coder defined by the International Telecommunication Union (ITU); the IP coders used for voice terminals connected directly to the Internet are standard ITU G.711, G.723, or G.729a coders. The transcoding means MT choose the type of transcoding to be effected as a function of the GSM and IP coders used. The transcoding means MT also process GSM signaling signals as defined in Recommendation 4.08 of the European Telecommunications Standards Institute (ETSI), for example, to transcode them into signaling signals conforming to an IP signaling protocol, such as the H323 protocol defined by the Internet Engineering Task Force (IETF) or the Session Initialization Protocol (SIP) defined by the ITU.

The interconnection means MI comprise an IP gateway through which the digital signal S_{N1IP} transcoded in accordance with the Internet Protocol reaches the Internet In. An Internet Telephony (Voice-over-IP (VoIP)) gateway can be used, for example, which integrates voice into packets transported in the Internet In. To manage transmission of the signal Slip, the interconnection means MI are associated with a one private branch exchange IPPBX supporting the Internet Protocol.

The routing means MR route voice and/or data I_{VD1IP} by switching Real-time Transport Protocol (RTP) packets toward the gateway GW1 (for example). The gateway GW1 adapts the GSM terminal GIP to the Internet by changing the signal format in both transmission directions.

The gateway GW2 adapts the standard telephone terminal FIP to the Internet by changing the signal format in both transmission directions.

The voice and/or data I_{VD1IP} can be received directly by the computer OIP.

Note that, despite the transmission system 10, a GSM terminal such as the terminal G1, G2 or G3 can receive calls in the conventional way from outside the network RP.

Of course, the foregoing description has been given by way of purely illustrative example. Any means can be replaced by equivalent means without departing from the scope of the invention. In particular, it is possible to provide each GSM terminal of the private network with a Bluetooth transceiver and to provide the private network with Bluetooth base stations, in order to use Bluetooth radio links instead of GSM radio links when the GSM terminals are in the coverage area of the private network. Voice/data signals are then transmitted in the GSM/Bluetooth terminals in the GSM 7.07 format, for example. Also, the mobile telephone service can also be of the PCS, UMTS, or CDMA type.

In one particular embodiment of the system 10, for which there is no need to connect standard terminals F1, F2, etc. (which are not IP compatible), the private branch exchange IPPBX is eliminated and the gateway 100 further comprises an IP router for routing identified data elements from the Internet In and a call server associated with the router and capable of managing standard call set-up protocols used in the Internet, such as the H323 protocol defined by the Internet Engineering Task Force (IETF) or the Session Initialization Protocol (SIP) defined by the ITU.

There is claimed:

1. An internetwork gateway for setting up a call between a GSM, UMTS, PCS or Bluetooth first mobile telephone terminal connected to a private telecommunication network and another terminal belonging to another network, addressable by means of an Internet address and adapted to send and receive RTP/IP voice and/or UDP/IP or TCP/IP data, which gateway includes transcoding means for transcoding information from the digital transmission protocol used in said first terminal to the protocol used in said second terminal and vice versa.

2. The internetwork gateway claimed in claim 1 further including transcoding means for transcoding signaling for the digital transmission protocol used in said first terminal to a real-time transport protocol used for digital voice transmission in said second terminal.

3. The internetwork gateway claimed in claim 1 further including interconnection means compatible with the real-time transport protocol used for digital voice transmission in said second terminal.

4. The internetwork gateway claimed in claim 1 further including a telephone private branch exchange compatible with the Internet Protocol for managing transmission of digital signals between said networks.

5. The internetwork gateway claimed in claim 1 further comprising an Internet router and a call server processing Internet Protocol call management protocols for managing transmission of digital signals conforming to said Internet Protocol between said networks.

6. The internetwork gateway claimed in claim 1 wherein said private network is a computer local area network or an integrated services private network.
